(19) United States
(12) Patent Application Publication
(10) Pub. No.: US 2009/0157869 A1
(43) Pub. Date: Jun. 18, 2009

(54) Tracking Content in Communication Networks

(76) Inventor: James D. Cleary, New South Wales (AU)

Correspondence Address: FULBRIGHT & JAWORSKI L.L.P., 600 CONGRESS AVE., SUITE 2400, AUSTIN, TX, 78701, US

(21) Appl. No.: 11/996,943

(22) PCT Filed: Jul. 27, 2006
(86) PCT No.: PCT/AU06/01043

§ 371 Date: Aug. 11, 2008

(30) Foreign Application Priority Data
Jul. 27, 2005 (AU) 2005904002

(51) Int. Cl. G06F 15/173

(52) U.S. Cl. 709/224

(57) ABSTRACT

The present invention relates to methods of, and systems for, tracking content in communication networks by collecting content transmission information from the network. The collected content transmission is examined to identify discrete content items, and these are compared to predetermined content items. The result of the comparison is stored on a database, and if an identified discrete content item is the same as or substantially similar to a predetermined content item and/or if an identified discrete content item has been previously sent to or received by a subscriber or application, an event signal is triggered.

### TECHNICAL FIELD

This invention relates to methods of, and systems for, tracking content in communication networks. The invention has particular but not exclusive application to person-to-person forwarding of content, specifically to tracking the forwarding of content between subscriber handsets on communication networks. Content items to be tracked can be in several formats including images, text, sound, music, video, games, executable programs or other types of content.

### BACKGROUND OF INVENTION

Content offered for sale to a subscriber may have been authored and/or packaged by a content provider. Alternatively, the content may have been created by commercial developers or by other individual subscribers. A known example of this is a subscriber purchasing ringtone content using an internet website, and receiving the content delivered to their handset via a message delivered via the communications network.

When a subscriber purchases content, the content provider may receive a royalty payment as part of the transaction. The royalty payment is sometimes called “revenue share”. Following delivery, the content is stored in memory on the subscriber's handset. The subscriber may then choose to forward the content to other subscribers using the communications network.

It is known to forward content using various methods including transmission via Internet Protocol (IP) and encapsulation in a message, including a Short Message Service (SMS) message, Multimedia Message Service (MMS) message, or email message. Content may be further encapsulated using a variety of methods, for example MIME encoding, or may be stored as plain text or other raw format.

It is also known to receive content via other protocols including Wireless Application Protocol (WAP), streaming media, or email before forwarding.

### SUMMARY OF INVENTION

The present invention aims to provide an alternative to known methods of and systems for tracking content in messages distributed between subscribers on a communications network.

This invention in one aspect resides broadly in a method of tracking content transmissions on a communications network, the method including:—

collecting content transmission information from the network;

examining the collected content transmission to identify discrete content items;

determining a signature for each content item and storing this with content transmission information in a database;

reporting on forwarding and content distribution events to determine if an identified discrete content item is the same or substantially similar to a previously transmitted content item sent or received by a subscriber or application;

storing the result of the comparison and/or determination, and

generating an event triggering signal if it is determined that an identified discrete content item is the same as or substantially similar to a predetermined content item, and/or if it is determined that an identified discrete content item has been previously sent to or received by a subscriber or application.

In one preferred embodiment the message content information is collected by passively examining messages during transmission by using an Internet Protocol packet capture device. The message content information may be collected by passively examining Internet Protocol traffic.

In another preferred embodiment the message content information is collected by monitoring a network element serving as a proxy to which messages are first sent during transmission.

In another preferred embodiment the content and content transmission information is collected by passively monitoring Internet Protocol traffic received and/or transmitted by a store-and-forward network element, for example a Multimedia Message Service Centre (MMSC), through which messages pass during transmission.

It is preferred that the collected message content information is examined by reassembling the message.

It is also preferred that the discrete content items include at least one of image, text, sound including music, video or other content type.

In one preferred embodiment text content is compared by using regular expression comparison techniques.

In one preferred embodiment t is preferred that content items are compared using comparison techniques, for example fuzzy logic comparison.

In one preferred embodiment image, video or sound content is compared by comparing checksums of the digitized content. Alternatively image, video or sound content can be compared by comparing a characteristic signature of the content, or by qualitative comparison methods comparing significant features of the content, or by utilising Content Based Image Retrieval (CBIR) comparison methods.

The comparison process can be optimised for rapid comparison of content. In one preferred embodiment the comparison process compares the characteristic signature of the content rather than the content itself.

The result can include the message sender's address, the message receiver's address, time of sending the message, time of receiving the message, and other information. An example of the address format could be MSISDN, email or Instant Messenger address.

The result can be stored as statistical information about the content.

In one preferred embodiment the signal triggers a billing event in a billing system.

In one preferred embodiment the signal triggers a business process. The business process may reward the creator of the original content with a promotional offer or other incentive.

In another aspect, the invention resides broadly in a method of tracking content in messages distributed between subscribers on a communications network, the method including:—

collecting message content information from the network;

examining the collected message content information to identify discrete content items;

comparing a characteristic signature of identified discrete content items with a characteristic signature of predetermined content items;

determining if a characteristic signature of an identified discrete content item is the same as or substantially similar to a characteristic signature of a predetermined content item and/or determining if an identified discrete content item has been previously sent to or received by a subscriber;

storing the result of the comparison and/or determination, and

generating an event triggering signal if it is determined that a characteristic signature of an identified discrete content item is the same as or substantially similar to a characteristic signature of a predetermined content item, and/or if it is determined that an identified discrete content item has been previously sent to or received by a subscriber or application.

In accordance with yet another aspect, the invention resides broadly in a system including logic stored on a computer readable medium for performing the method described above.

### DESCRIPTION OF DRAWINGS

In order that this invention may be more easily understood and put into practical effect, reference will now be made to the accompanying drawings which illustrate a preferred embodiment of the invention, wherein:—

FIG. 1 shows a workflow whereby messages are used to transmit an image;

FIG. 2 shows a summary of the billing information collected by the communications network in accordance with a preferred embodiment of the present invention;

FIG. 3 shows the path of an image resolved in accordance with a preferred embodiment of the present invention;

FIG. 4 is a flow chart describing operation of the method in accordance with a preferred embodiment of the present invention.

### DESCRIPTION OF PREFERRED EMBODIMENT OF INVENTION

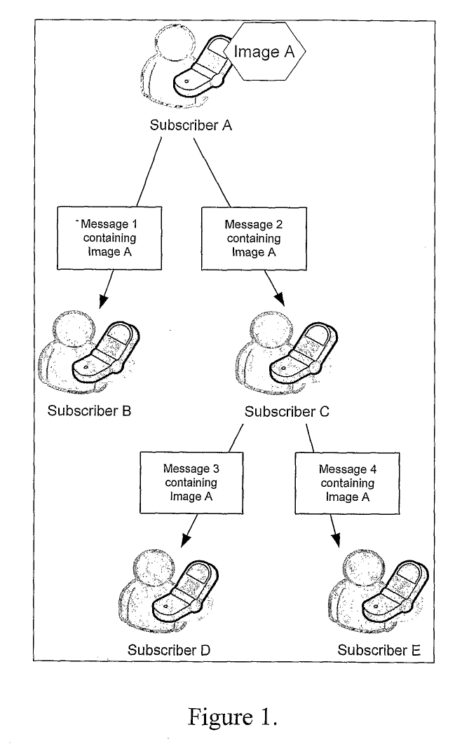

Turning by way of example to a preferred embodiment of the invention as seen in a system wherein image content is encapsulated in an MMS message and forwarded between subscribers, FIG. 1 shows how the messages are used to transmit the image.
1. Subscriber A sends Image A to Subscriber B via Message 1
2. Subscriber A sends Image A to Subscriber C via Message 2
3. Subscriber C sends Image A to Subscriber D via Message 3
4. Subscriber C sends Image A to Subscriber E via Message 4

It will be noted that the message encapsulating Image A may also contain additional types of content. For example, the subscriber may add, change or delete a text component of the message before forwarding the content.

In this example, the Multimedia Message Service Centre detects when a subscriber sends a message and generates an event triggering signal, for example a billing event in order to charge the subscriber for the cost of the message. However this information is limited to basic message information such as the sender's phone number, the receiver's phone number and the time. The communications network has not detected the path of Image A being forwarded between users, but rather has detected that four discrete message transmission events have occurred, without being able to establish a relationship between them.

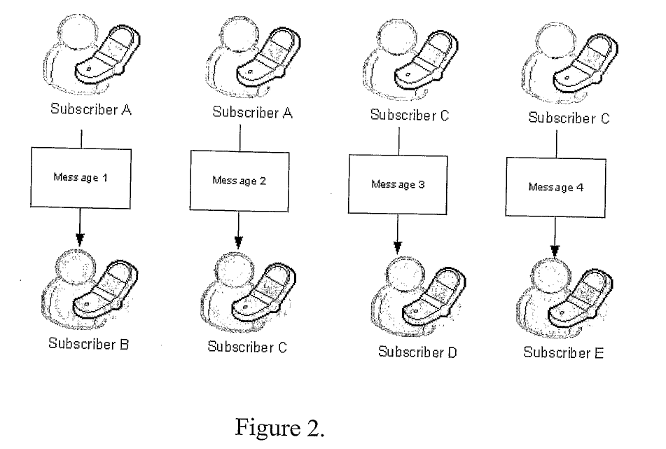

FIG. 2 shows a summary of the billing information collected by the communications network in the example above as being:
1. MMS Message sent from Subscriber A to Subscriber B
2. MMS Message sent from Subscriber A to Subscriber C
3. MMS Message sent from Subscriber C to Subscriber D
4. MMS Message sent from Subscriber C to Subscriber E

This billing information shows a set of discrete message events and does not show the relationship that Image A was forwarded in the path shown in FIG. 1.

In accordance with the present invention, the path of content is then tracked as it is distributed from person to person on the communications network. Therefore the present invention is able to track the content transmission events as being:
1. Image A sent from Subscriber A to Subscriber B
2. Image A first sent from Subscriber A to Subscriber C, and then forwarded by Subscriber C to Subscribers D and E.

Information regarding content sent or received by a subscriber is collected by examining messages stored in the communication network message server (for example the MMSC or SMSC), or by passively examining content as it is transmitted by the communications network using an Internet Protocol packet capture device. While MMS and SMS are discussed in this paragraph as examples, all types of content may be tracked using the present invention, regardless of whether the content is encapsulated in a message or not. The Internet Protocol transmissions (for example Internet Protocol traffic) are passively examined, or a network element is provided to serve as a proxy during transmission.

Each collected content transmission is then examined by disassembling the message, which may previously be in an easily accessible or a raw format, in order to resolve the content contained in the message. The content may take the form of several content items, for example an MMS message might contain images, text and music, and in this case each content item is resolved.

A comparison process based on predetermined rules is utilised for each component of content to determine if the content component is the same as or substantially similar to a predetermined list of content which is of particular interest, and/or to identify if the content has been previously detected.

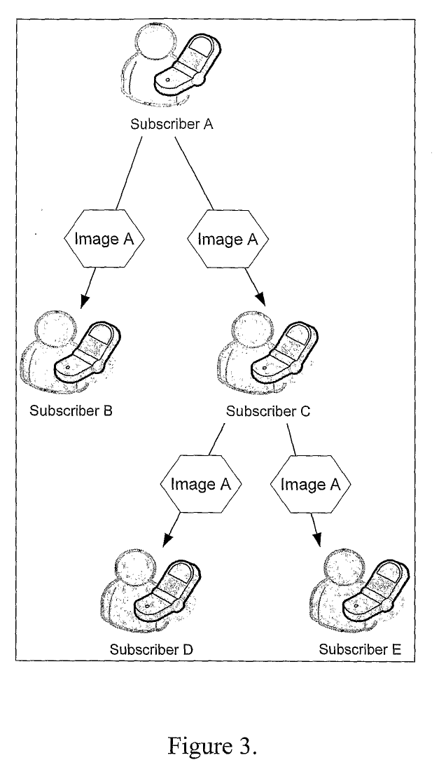

Hence, as shown in FIG. 3, the transmission path of the Image A may be determined.

The result of the content comparison is stored, and depending on the result, an event triggering signal can be generated for use by an external system. The external system could be a billing system for example.

It will also be appreciated that subscriber privacy or lawful privacy restrictions may require that users opt-in or provide consent for use of the present invention. In such circumstances, the comparison process may compare the content characteristic signature rather than the content itself. Alternatively in order to protect the privacy of subscribers, the event triggering signal may include:
1. Only statistical information about the content can be reported (for example the total number of times the content has been forwarded), rather than details of the path itself being stored
2. Private information may be removed from output reports. This may involve obfuscating or anonymising information reported about the content or the content transmission, for example the content identifier, the sending address and the receiving addresses.

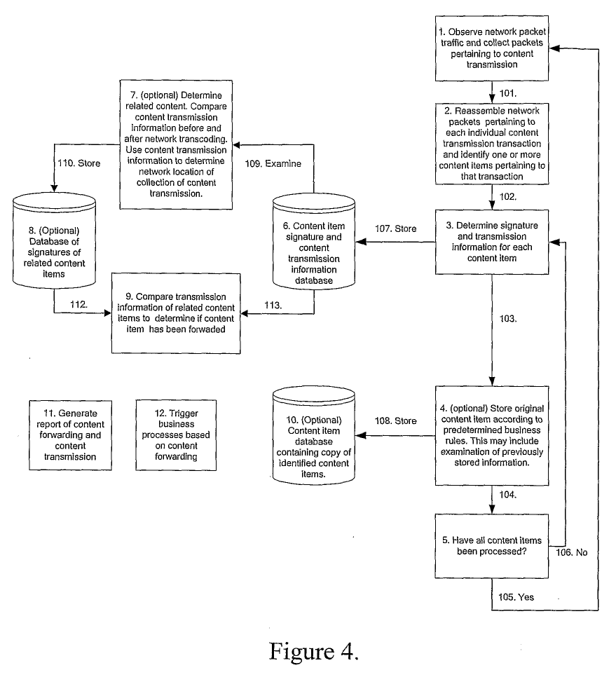

Turning now to the flow chart illustrated in FIG. 4, an example of the present invention is shown as:
1. Internet Protocol packets are collected by monitoring network traffic. For transmission of an MMS message this could include MM1, MM4 and/or MM7 protocols. Non-message content transmission including Wireless Application Protocol (WAP) and Hypertext Transfer Protocol (HTTP) content downloads to the handset may be collected in the same way. A packet capture filter may be used to increase the efficiency of packet collection.
2. The Internet Protocol packets are reassembled to reassemble the original content transmission, and the content items in each transmission identified.
3. The characteristic signature of each content item is determined and stored in a database (6.) with the associated content transmission information. In the case of multiple content items per transmission, a record for each content item transmission is stored separately with a separate copy of the associated content transmission information. In case of one content item sent to multiple recipients, a record for the content transmission is stored separately for the sender and each recipient. The content transmission information may include:
   a. the sender's and receiver's address, in a format that may include a combination of
      i. MSISDN,
      ii. email address,
      iii. Internet Protocol address
      iv. application or service identifier,
      v. Instant Messenger (IM) address,
      vi. Content provider identifier, and
      vii. other address formats that identify a user, company, application or network
      viii. Fields described in the Open Mobile Alliance (OMA) specification related to MMS and content transmission
   b. the address of the network elements transmitting and receiving the message, for example the MMSC, WAP gateway, or proxy
   c. the time of sending and the time of receiving the transmission, and other times as reported by network elements involved in the transmission,
   d. the device profile of the sender's and receiver's handsets and browsers, for example the User Agent Profile (UAProf)
   e. the network location where the transmission was collected
   f. references to other content items that were included in the same content transmission,
   g. transaction identifiers that were set by the sender or receivers handsets and network elements (for example MMSC or email server) to identify the content transmission.
4. Optionally, the original content item may be stored in database (10.). Predetermined business rules may be used to determine if the content item should be stored, and may examine historical data stored in databases (6., 8. and 10.). An example is whereby the databases are examined to determine if a related content item has already been transmitted more than a certain number of times and therefore an original copy of the content item may be stored for use in a later report.
7. Optionally, determine content items that are different but related. This is advantageous in a communication network where a content item may be adapted to a format that is suited to the destination handset (also referred to as “transcoding”). By examining the database (6.) and determining content items that are part of the same transmission but have been modified, a list of related content items is determined and stored in a database (8.). This is assisted by collecting network packets (1.) at multiple points in the network, for example before and after the network element that may adapt the content.
9. Forwarding of content between users is determined by examining the transmission information for related content items. Related items are determined as those that have the same signature. Database (8.) may optionally be used to determine the items are related but have different signatures. A forwarding path may be determined by examining the time of transmission, the transmission address information, and comparing the similarity of content items in each record of database (6.).
11. Periodic or ad-hoc reports may generated by applying reporting rules to the information in databases (6., 8., and 10.).
12. Business processes may be triggered according to predetermined business rules and the information in databases (6., 8., and 10.) examining datasets or update records in the content item signature database (6.)

It is noted that to facilitate embodiments of the present invention described below and to improve searching of items in the databases (6., 8., and 10.) each content item may have additional information stored including:
(a) Encoding information—examples of image content encodings are MPEG, GIF, BMP and other image formats
(b) Content quality information—examples of image quality information are resolution, colour depth
(c) Other information about the content items

It will be appreciated that the present invention may be used to track content transmitted to or from applications as well as to or from subscriber handsets. For example, content may be tracked from a content provider to a handset (using MMS, Wireless Application Protocol, Web download or email or other transfer mechanism) and as the same content item is forwarded to other subscribers.

### Preferred Embodiments

### Qualitative and Binary Content Comparison

The nature of the content comparison process depends on the type of content being examined, thus the present invention may be embodied to use a plurality of methods to compare content items.

The range of methods to compare the similarity of content items includes:
(a) Regular expression comparison,
(b) Binary comparison,
(c) Qualitative comparison,
(d) Other methods

Regular expression comparison is well suited to text content but may also be suitable for other types of content including executable applications.

Binary content comparison may be used whereby the content item signature determined in function (3.) and stored in databases (6., 8. and 10.) is a unique digital signature, for example a binary checksum (or “hash”) of each content item. An example of this is an MD5 hash of the content item, which allows for binary comparison in the comparison function (9.) and reporting function (11.) to identify transmission of related content items. This has the advantage that it is a computationally efficient way to compare the similarity of content items in function (9.).

Qualitative content comparison may be used whereby content is determined according to the type of content being compared and/or the configuration of business rules. In this embodiment the signature determined in function (3.) is a set of representative information concerning the content rather than a binary representation. A non-exclusive list of qualitative comparison methods that may then be used to determine similarity between content items include:
Content-based Image Retrieval (CBIR) search methods,
Region-based Image Retrieval (RBIR) search methods,
Multi-resolution wavelet decomposition, or
Other methods that provide comparison of the similarity of two items of content

In some types of qualitative comparison, the similarity reported by the comparison is compared to a configurable similarity threshold, to determine if the content is substantially similar, and whether a content match has been found. It will be appreciated that the comparison process can be optimised for rapid comparison of content.

This has the advantage that it will support content tracking even if the content has been transcoded by an external (or “interconnected”) communications network that does not have the present invention installed, and the content transmitted back to the home network where it can again be tracked.

### Preferred Embodiment

### Support for Content Adaptation History

Currently, there is variation between the capabilities of different handsets; for example the screen resolution, colour depth and graphics encoding format. For this reason, when content is forwarded between handsets or sent from an internet content provider, the communications network may modify the format of the content to a form suitable for the receiving handset. This is called sometimes called content adaptation, transcoding, or content rendering. Examples of transcoding are resizing images, changing the resolution of images, changing the encoding of an audio stream, or splitting a video into an animated GIF and sound.

A preferred embodiment of the present invention is to utilise mechanism (7.) to identify content that has been adapted. By collecting network traffic (1.) at two or more points in the communication network, for example before and after content items are processed by an external content adaptation (“transcoding”) device, related content items may be determined and stored in a database that shows relationships between content (8.). This allows tracking of content that has been transcoded regardless of whether qualitative or binary content comparison is used in mechanism (9.) and the reporting and alerting functions (11. and 12.).

### Advantage of Present Invention

### Passive Content Tracking

A preferred embodiment of the present invention is to track the path of content while being passively connected to the network. This overcomes disadvantages of an alternative method whereby the logs of discrete messages stored by network components are examined, for example the Multimedia Messaging Service Centre (MMSC) or WAP gateway, including:
1. Network components may use proprietary data formats that make it difficult or computationally expensive to examine message logs and require cooperation or license from the network component vendor
2. Multiple network components may be used in parallel, so no one component can reliably track the path of content as it is forwarded
3. Subscriber handsets may utilise different content formats and therefore content may be reformatted when it is forwarded between handsets of different capability
4. Operating content tracking technology on a network component may place excessive load on the component
5. Operating content tracking technology on a network component may reduce reliability of content transmission, by introducing an additional logical single point of failure affecting normal content transmission
6. Restrictive commercial terms, for example supportability of turnkey environments when 3^{rd} party components are introduced, may commercially or technically prohibit integration to certain network elements or their supporting networks

The passive content collection aspect of the present invention helps to overcome these problems by monitoring all relevant content transmission on the network, and not relying on any existing network component to generate content tracking information.

### Advantage of Present Invention

### Network Centricity

The present invention operates by collecting traffic (1.) being transmitted by the communications network and so is not limited to use with specific types of handsets or software agents operating on handsets. This has considerable advantage over mechanisms that require a software agent or other specific functionality to be present in handset, which thereby limit the utility to a subset of handsets and therefore to a subset of subscribers.

### Preferred Embodiment

### Determining Marketing Information

It is not currently practicable to collect marketing information about the specific content that subscribers forward to other subscribers. This information is useful to help determine the content that is compelling to subscribers, and to help telecommunication operators and content providers determine the pattern and characteristics of how these users distribute the content.

Telecommunications operators could then tailor their commercial offering to maximise the commercial benefit of the content they offer to subscribers. A further application of this embodiment is that marketing companies could track and report on person-person marketing campaigns, also know as “viral marketing”.

The present invention tracks forwarded content and identifies the patterns of content forwarding through reporting functionality (11.). The invention can generate behavioural content information and subscriber information which may then be used to assist compiling subscriber data. The information includes:
a. which items of content users forward most often,
b. which users are most likely to forward content,
c. how often content is forwarded, and
d. other information.

The present invention has advantages over current methods of collecting marketing information about content and subscribers, because the current methods:
a. do not track the path of content as it is passed from subscriber to subscriber in the network,
b. may rely on mechanisms that may not work on certain subscriber handsets,
c. may require specific actions on the part of the subscriber which are contrary to normal operation of the handset, for example entering codes in the message or sending the message in a different format, or
d. may require manual polling or questioning of the subscribers

Furthermore, social network methods from the field of sociology may be applied to the data to models social network characteristics within a subscriber population. This allows the determination through the reporting mechanism (11.) of influential subscribers and influential content.

### Preferred Embodiment

### Context-Sponsored Content

Search engines and business contact databases, for example Google, have a database of subscriber and business information that can be monetised using sponsored messaging. In this scenario a subscriber would be rewarded for allowing a sponsored advertising message to be appended to each content item that the subscriber sends.

Using the present invention:
1. the content of the message, for example a company logo or promotional image, can be examined and compared to pre-determined commercial content signatures using the reporting mechanism (11.), or
2. a business process may be triggered using the mechanism (12.) to provide credit or other incentive to subscribers for including the company logo or promotional image as a part of the subscriber's person-person message

### Preferred Embodiment

### Enhanced Marketing Profiling Through Lookup to Directory Databases

An application of the present invention is to extend known subscriber information by performing a lookup into a directory database.

The present invention can be applied to:
1. Detect person-person content transmissions of consumer or commercial content through functions (11. and 12.),
2. Reports or business processes are triggered using a reverse-lookup of subscriber information, for example using the subscriber's phone number as a key, into an external database, for example a Customer Relationship Management database
3. The reverse-lookup is then used to trigger a separate business process or report, based on the joined, and extended information from the data created in the present invention and the external database.

This method could be used to resolve information similar to name of the subscriber, home address of the subscriber, alternative phone numbers for the subscriber and other information.

A partitioned, role-based privacy framework may be used to control how this data is mined, used and sold. This may be applied to data acquisition, for example by tracking opt-in subscriber transactions, and in reporting to protect subscriber and company privacy.

### Preferred Embodiment

### Sales Lead Verification

Business directories, for example a phone directory, and consumer sale directories, for example classifieds, place a high value on ability to connect customers to suppliers.

It may be argued that a directory's commercial value is enhanced by the ability to quantify their advertising value to customers. The present invention has the potential to provide direct, quantified value for directory businesses.

An embodiment of the current invention is to send content containing company information from a directory website to a subscriber's phone. Even if the message is forwarded between subscribers, for example from one subscriber's contact phone book to another, the present invention could be used to demonstrate a direct link between a directory listing and the sales lead, thereby directly demonstrating value to the directory's customers.

### Preferred Embodiment

### Content Distribution

Subscribers can currently forward content from their handset or device to another subscriber. This is sometimes referred to as viral marketing or viral distribution. Currently, the content may be forwarded to other subscribers using the communications network without this being easily detected. Consequently it is not practical to create an economic model based on content forwarding events, for example where the content provider would receive a royalty payment for forwarding of commercial content.

Current known mechanisms developed to restrict access to certain content forwarded between subscribers include:
a. Forward-locked content, whereby an attribute of the content is interpreted by the handset so as to disallow forwarding of the content to another subscriber. This has the disadvantage that many handsets are not capable of correctly reacting to the forward-lock content attribute.
b. Key-locked content, whereby content may be forwarded by a subscriber in a locked format, so the receiving subscriber cannot properly access the content without purchasing a key directly from the content provider. This has the disadvantage that many handsets are not capable of managing such locked content.
c. Notification-locked content, whereby the subscriber may access content only after a software agent residing on the subscriber's handset or as a content item itself, has provided notification to the content provider. This has the disadvantage that many handsets are not capable of providing such notification.

These locked-content mechanisms have the disadvantage of requiring a handset with the extra functionality for identifying and handling the locking mechanism described above, thereby limiting the suitability to a subset of the subscriber population. They have additional disadvantages in requiring the purchasing subscriber to find the correct mechanism to purchase the content from the content provider, for example using a code within a premium SMS message, or by visiting a website, and this inhibits distribution of the content.

The present invention is advantageous in that it generates data to support an economic model for content distribution without the disadvantages discussed. The subscriber may forward certain content to other subscribers without restriction, the content transmission being reported (11.) and a corresponding forwarding event logged (12.), whereby the forwarding event can be used for a number of purposes including
a. generating a royalty payment for the content provider,
b. deducting or crediting a content charge form the sending or receiving subscriber's billing account, or
c. tracking and generating statistical information on the path of particular content.

The present invention thus overcomes a number of disadvantages with current methods including:
a. difficulty for subscribers to determine the way to access person-person content, because they must purchase the content from the content provider, and
b. difficulty for subscribers to purchase or use content that is protected by forward-lock or key-based restrictions

An embodiment of the present invention as is that certain content providers may not directly receive a royalty payment each time content is forwarded, however the value of the content they offer to subscribers may be measured by the market penetration of the content within a subscriber population. For example, a content provider who permits content distribution without direct royalty may value their content by its popularity among subscribers. Therefore the invention allows the content provider to more accurately market their content with partners and determine the value of their content.

### Preferred Embodiment

### Encouraging Subscribers to Create Popular Content

A preferred embodiment is to generate a financial incentive for subscribers who introduce content that is compelling to other subscribers. The invention is used to create a billing event when content created by a subscriber is forwarded by another subscriber. Thus with reference to FIG. 3, it will be appreciated that the system can detect that Subscriber A introduced content that was forwarded to the subscriber population. Therefore, when that content is forwarded from subscriber D to subscriber E, an event such as a financial rebate can be generated to reward Subscriber A. This embodiment of the invention is referred to as “FriendsWhoForward”.

### Preferred Embodiment

### Monitoring the Behaviour of Particular Subscribers

In the case of security purposes, it may be useful to monitor the content that a particular subscriber interacts with. This can be monitoring the content they created, or content that they received form or forwarded to other subscribers. FIG. 3 shows how the invention allows the social network surrounding C to be modelled and the path of content that the subscriber has accessed.

Similarly, the present invention may be used to detect certain content that is not suitable for the destination subscriber by examining information regarding the subscriber's age, and blocking transmission of the content if it does not meet suitable age classification for the subscriber.

### Preferred Embodiment

### Enhancing the Quality of Content

As previously described, adaptation of content may occur in communications networks. A disadvantage of this is that when content is forwarded from handset to handset several times, the quality may be subsequently reduced through transcoding to the quality of the lowest handset in the forwarding path. This content item quality may be thought of as a “lowest common denominator” of the chain of handsets have forwarded the content.

With current systems the low-quality content item can not be linked to the related previously-transmitted higher-quality content items and so the subscriber may receive a content item that is not the optimal quality, regardless of the ability of their handset.

An embodiment of the present invention can detect related content items of a certain quality, and hence replace the content during transmission process with content that is optimally suited to the destination handset by:
(a) receiving from an external content adaptation system a query containing the destination handset information and content item,
(b) querying an external database of handset information to determine the optimal content format for the destination handset,
(c) determining the signature of the content item as in function (3.),
(d) querying the database of related content items (8.) to determine the signature of a related content item that has improved quality in that it more closely meets the format determined in step (b)
(e) querying the original content item database (10.) with the content signature determined in step (d) to retrieve the corresponding original content item of improved quality
(f) returning to the external content adaptation system the content item of improved quality for delivery to the destination handset
   In this way, optimal content quality may be maintained even as the content is forwarded multiple times between handsets of varying quality.

### Preferred Embodiment

### Reporting on Copyrighted Content and Content of Interest

The invention can also be utilised to detect content of a certain type, by comparison of the collected content to a reference of copyrighted content, in order to report forwarding of content that contravenes intellectual property rights of the content author or content provider.

In this case, the invention operates as a proxy-server intercepting traffic and stopping further transmission of content to the destination handset. The original content may be replaced with a message to advise the destination subscriber that the content was removed. Alternatively, the invention may be embodied as a passive reporting or alerting tool without modifying the content.

A further example of this embodiment is whereby undesirable content, for example:
(a) a mobile virus,
(b) illegal or undesirable content, or
(c) content of specific interest

may be detected and a report provided or business process triggered.

The content forwarding information stored in the database shown in FIG. 4 may be also used to trace the source and distribution path of the content item.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. A method of tracking content in messages distributed between subscribers on a communications network, the method including:—
collecting message content transmission information sent or received by a subscriber;
examining the collected content transmission information to identify discrete content items;
comparing identified discrete content items with predetermined content items;
determining if an identified discrete content item is the same as or substantially similar to a predetermined content item and/or determining if an identified discrete content item has been previously sent to or received by a subscriber or application;
storing the result of the comparison and/or determination, and
generating an event triggering signal if it is determined that an identified discrete content item is the same as or substantially similar to a predetermined content item, and/or if it is determined that an identified discrete content item has been previously sent to or received by a subscriber.

2. A method of tracking content as claimed in claim 1, wherein the message content transmission information is collected by examining messages stored in a network message server.

3. A method of tracking content as claimed in claim 1, wherein the message content transmission information is collected by passively examining messages during transmission by using an Internet Protocol packet capture device.

4. A method of tracking content as claimed in claim 1, wherein the message content transmission information is collected by passively examining Internet Protocol traffic.

5. A method of tracking content as claimed in claim 1, wherein the message content transmission information is collected by monitoring a network element serving as a proxy to which messages are first sent before being transmitted.

6. A method of tracking content as claimed in claim 1, wherein the collected message content transmission information is examined by decompiling the message.

7. A method of tracking content as claimed in claim 1, wherein the discrete content items include at least one of image, text, audio including music, video, application.

8. A method of tracking content as claimed in claim 7, wherein text content is compared by using regular expression comparison techniques.

9. A method of tracking content as claimed in claim 7, wherein image, video or sound content is compared by comparing checksums of the digitized content.

10. A method of tracking content as claimed in claim 7, wherein image, video or sound content is compared by comparing a characteristic signature of the content.

11. A method of tracking content as claimed in claim 7, wherein image, video or sound content is compared by qualitative comparison methods comparing significant features of the content.

12. A method of tracking content as claimed in claim 7, wherein image, video or sound content is compared by utilising Content Based Image Retrieval (CBIR) comparison methods.

13. A method of tracking content as claimed in claim 1, wherein the comparison process is optimised for rapid comparison of content.

14. A method of tracking content as claimed in claim 1, wherein the comparison process compares a characteristic signature of the content rather than the content itself.

15. A method of tracking content as claimed in claim 1, wherein the result is stored as statistical information about the content.

16. A method of tracking content as claimed in claim 1, wherein the signal triggers a billing event in a billing system.

17. A method of tracking content in messages distributed between subscribers on a communications network, the method including:—
collecting message content information from the network;
examining the collected message content information to identify discrete content items;
comparing a characteristic signature of identified discrete content items with a characteristic signature of predetermined content items;
determining if a characteristic signature of an identified discrete content item is the same as or substantially similar to a characteristic signature of a predetermined content item and/or determining if an identified discrete content item has been previously sent to or received by a subscriber;
storing the result of the comparison and/or determination, and
generating an event triggering signal if it is determined that a characteristic signature of an identified discrete content item is the same as or substantially similar to a characteristic signature of a predetermined content item, and/or if it is determined that an identified discrete content item has been previously sent to or received by a subscriber.

18. A method of tracking content transmitted on a communications network, the method including:—
collecting content transmission information sent or received by a subscriber or application;
reassembling the collected content transmission information to identify discrete content items; and
determining and storing a characteristic signature for each content item with an associated content item transmission information in a database.

19. A method of tracking content as claimed in claim 18, wherein the characteristic signature and transmission information for each content item is compared with a previously stored content item signature and transmission information to determine if the same or substantially similar content item has been previously sent to or received by a subscriber or application; and
storing the result of the comparison.

20. A method of tracking content as claimed in claim 19, wherein the result of the comparison is used to determine and/or report on the transmission of identical or related content items between subscribers, and between subscribers and applications.

21. A method of tracking content as claimed in claim 19 wherein the result of the comparison is recursively searched to determine the transmission path of identical or related content, as opposed to discrete content transmission events.

22. A method of tracking content as claimed in claim 19 wherein the result of the comparison is used to count the number of times a content item has been transmitted on the network.

23. A method of tracking content as claimed in claim 18, wherein a hierarchy of content item signatures are stored to record a relationship between content items that are part of the same transmission but have been modified.

24. A method of tracking content as claimed in claim 23 wherein related content items are determined by collecting network packets at multiple points in the network, including before and after the network element, that may adapt the content.

25. A method of tracking content as claimed in claim 19 wherein according to predetermined business rules, a copy of the original content is stored with the associated characteristic signature.

26. A system including logic stored on a computer readable medium for performing the method according to any one of claims 1, 17 and 18.
